(19) United States
(12) Patent Application Publication
(10) Pub. No.: US 2004/0039656 A1
(43) Pub. Date: Feb. 26, 2004

(54) Method and arrangement for ascertaining total price data in a mobile-radio-assisted ordering process

(75) Inventors: Heiko Gerber, Berlin (DE); Robert Hagen, Berlin (DE); Lorene Hoerner, Berlin (DE); Martin Kissner, Kremmen (DE); Klaus Krause, Berlin (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/459,700

(22) Filed: Jun. 12, 2003

(30) Foreign Application Priority Data
Jun. 13, 2002 (DE) 10227395.2

(51) Int. Cl. G06F 17/60

(52) U.S. Cl. 705/26; 705/1

(57) ABSTRACT

The invention relates to a method and a pricing system for ascertaining total price data in a mobile-radio-assisted ordering process. In this context, following transmission of order data, performed using a mobile radio network, from an ordering communication terminal to a provider communication terminal associated with a service provider, a pricing system is supplied with ordering data, associated with the order data, by the provider communication terminal. The pricing system uses network use data, which are transmitted by the mobile radio network and appear in connection with the ordering process, to select from a volume of price-influencing data stored in an influence memory the price-influencing data which are associated with the ordering process, and the ordering data and the read price-influencing data are used to ascertain the total price data concerning the ordering process.

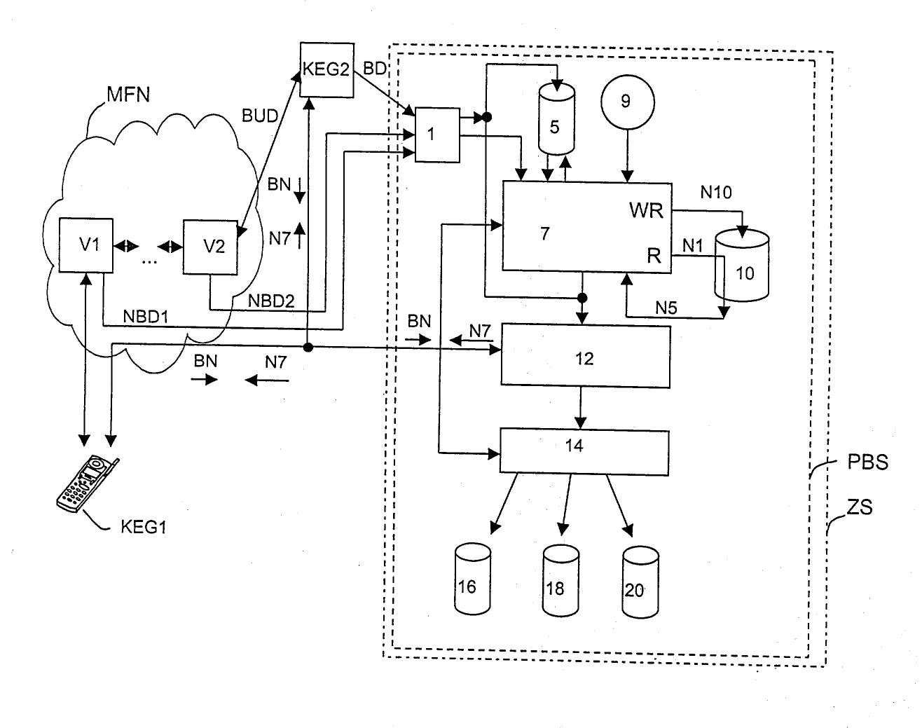

In future, the opportunities of mobile-radio-assisted communication will be used ever more frequently in order to conduct ordering processes which involve a customer's ordering communication terminal being used to transmit order data to a service provider's provider communication terminal via a mobile radio network, where the order data concern an order for goods or services, for example.

The invention is based on the object of specifying a method and an arrangement which can be used for easily and reliably ascertaining price data associated with such ordering processes.

The invention achieves this object by means of a method for ascertaining total price data in a mobile-radio-assisted order process, in which, following transmission of order data, performed using a mobile radio network, from an order communication terminal to a provider communication terminal associated with a service provider, a pricing system is supplied with ordering data, associated with the order data, by the provider communication terminal, the pricing system uses network use data, which are transmitted by the mobile radio network and appear in connection with the ordering process, to select from a volume of price-influencing data stored in an influence memory the price-influencing data which are associated with the ordering process, and the ordering data and the read price-influencing data are used to ascertain the total price data concerning the ordering process. A particular advantage of this method is that use of the mobile radio network in the course of the ordering process is taken into account when ascertaining the total price data, by using network use data which arise in connection with the ordering process (e.g. time and duration of a mobile radio link which has been set up or volume of data transmitted via the mobile radio network for the order). Advantageously, these network use data are used to select from a volume of price-influencing data stored in an influence memory (which price-influencing data can be table data for a graduated discount scale, for example) the price-influencing data which are associated with the respective ordering process; these price-influencing data are taken into account when ascertaining the total price data.

The inventive method can proceed such that the total price data are ascertained directly after the ordering data have arrived at the pricing system. An advantage in this context is that the total price data are ascertained during the actual ordering process early enough (virtually or actually in real time) for them to be able to be transmitted to, by way of example, the provider communication terminal or to the ordering communication terminal “online” during the actual ordering process.

The inventive method allows ordering data and network use data arriving at the pricing system to be stored in a data store in the pricing system. This advantageously means that ordering data and network use data which are currently arriving are stored and archived for subsequent further use.

The inventive method can also proceed such that old ordering data and old network use data stored in the data store in the pricing system are used in addition to the network use data and ordering data currently transmitted by the mobile radio network to select the price-influencing data which are associated with the ordering process. An advantage of this refinement of the inventive method is that the use of the old ordering data and of the old network use data means that it is also possible to take into account past ordering processes or past network uses when ascertaining the total price data.

The inventive method can proceed such that upon receipt of current ordering data or current network use data, the price-influencing data stored in the influence memory are aligned with these received data by overwriting a selection of the stored price-influencing data with new price-influencing data. This advantageously allows the price-influencing data to be aligned with current ordering processes or with current uses of the mobile radio network.

The method can preferably proceed such that the ascertained total price data are transmitted to the provider communication terminal and/or to the ordering communication terminal. This means that the provider or the orderer is informed about the total price data directly after they have been ascertained.

In addition, the inventive method can be in a form such that the provider communication terminal and/or the ordering communication terminal is prompted to transmit an acknowledgement message concerning the total price data to the pricing system, arrival of the acknowledgement message at the pricing system is registered as a declaration of agreement concerning the total price data, and failure of the acknowledgement message to arrive at the pricing system causes the total price data to be rejected. This advantageously allows the provider communication terminal and/or the ordering communication terminal to check the total price data and to use an interactive process to accept (i.e. to declare agreement) or to reject the total price data.

The inventive method can also be in a form such that the ascertained total price data are split into mobile radio price data concerning the mobile radio network, provider price data concerning the service provider, and pricing price data concerning the pricing system on the basis of information contained in the current ordering data and in the current net work use data. This advantageously allows separate entry of various price data types; furthermore, the price data can be subsequently billed very easily and inexpensively, for example.

The inventive method allows the mobile-radio price data to be stored in a mobile-radio price memory, the provider price data to be stored in a provider price memory, and the pricing price data to be stored in a pricing price memory.

The aforementioned object is likewise achieved by the invention by means of a pricing system having an influence memory for storing a volume of price-influencing data, a data reception device for receiving ordering data, which concern an ordering process carried out using a mobile radio network and for receiving network use data for the mobile radio network, and a price-determination unit, whose input side is connected to the influence memory and to the data reception device, for ascertaining total price data concerning the order. This system advantageously involves the data reception device receiving not just the ordering data but also the network use data for the mobile radio network, so that both the ordering data and the network use data can be used by the price-determination unit to ascertain the total price data. In addition, the pricing system advantageously has an influence memory; the price-influencing data stored in this influence memory allow the total price data to be ascertained on the basis of individual orders.

The inventive pricing system can have a data store, whose output side is connected to the price-determination unit, for storing incoming ordering data and network use data. This data store advantageously allows the incoming data to be stored for the purpose of further use in the future.

The inventive pricing system can also have a distributor unit, connected to the output of the price-determination unit, and a plurality of price memories whose input side is connected to the distributor unit. This distributor unit advantageously allows the total price described by the total price data to be split into individual prices; the associated individual price data can be stored in the price memories. These individual prices can be associated with the various parties involved in the ordering or business process.

To explain the invention further, the single FIGURE schematically shows an exemplary embodiment of a pricing system and an exemplary embodiment of a method which proceeds using the pricing system.

The FIGURE schematically shows a mobile radio network MFN which can be, by way of example, a second or third generation mobile radio network. This mobile telephone network can be, in particular, in the form of a GSM mobile radio network (GSM=Global System for Mobile Communications) or in the form of a UMTS mobile telephone network (UMTS=Universal Mobile Telecommunications System). Of this mobile radio network MFN, only a first switching center V1 and a second switching center V2 are shown by way of example. An ordering communication terminal KEG1 (for example a mobile telephone, a lap top or a palmtop with a mobile radio interface) is now intended to be used to perform an ordering process with a service provider. Such an ordering process can be used, by way of example, to order goods (e.g. domestic electronic appliances or groceries) or services (e.g. delivery of market prices or economic news) from the service provider. To perform such ordering processes, the service provider has a provider communication terminal KEG2. This provider communication terminal can be, by way of example, a mobile telephone or a computer with a mobile radio interface. To perform the ordering process, the ordering communication terminal KEG1 is used to set up a mobile radio link to the provider communication terminal KEG2 via the first switching center V1 and the second switching center V2 in the mobile radio network MFN; this communication link is used to transmit order data BUD to the provider communication terminal KEG2. In this context, order data are to be understood to mean such data as are associated with an order for goods or a service and contain information concerning this order. The provider communication terminal KEG2 receives these order data; hence, the service provider knows that an ordering process and hence an order are in progress.

The order data contain at least one character identifying the sender of the order data (for example his mobile radio telephone number MSISDN associated with the ordering communication terminal KEG1—e.g. by means of a “SIM card”—at the time of the order) and a descriptor for the ordered goods or service.

The provider communication terminal KEG2 then generates ordering data BD associated with the order data BUD. To this end, the information contained in the order data BUD can be transferred unchanged to the ordering data BD; in addition, it is also possible to add further information about the ordering communication terminal KEG1, the user of the ordering communication terminal or about the ordered goods or service (for example a basic price for the ordered goods or service). All of this information is sent as ordering data BD to a data reception device 1 in a pricing system PBS. The pricing system PBS is part of a more extensive payment system ZS; alternatively, the pricing system PBS can be in independent form. The pricing system PBS will now be used to ascertain total price data describing a total price for the goods or service. These total price data describe, by way of example, the final gross price which can later be invoiced to the user of the ordering communication terminal, that is to say to the orderer. The calculation of these total price data includes not only the basic price, transmitted with the ordering data by the provider communication terminal, for example, for the goods or service but also the manner in which the mobile radio network MFN is used to perform the ordering process and/or a goods or data delivery process. It can likewise take into account ordering processes from the past. Such ordering processes from the past will generally be ordering processes which were performed using the ordering communication terminal KEG1 or else using another ordering communication terminal using the same character (e.g. MSISDN number) identifying the sender of the order data (that is to say using precisely that sender character which is also involved in the current order). Alternatively, other ordering processes from the past which were performed by indicating other sender characters can be taken into account. Such sender characters can be, by way of example, mobile radio telephone numbers for orderers belonging to a predetermined group (e.g. family, company division, business) and as such have entered group agreements (e.g. group mobile radio agreements). For the inventive method, it is generally advantageous if the senders use an identifying character which is associated with a mobile radio agreement concluded between them and an operator of the mobile radio network.

For the purpose of ascertaining the total price data, the data reception device 1 transmits the received ordering data to a data store 5, where they are stored. The ordering data are likewise transmitted from the data reception device 1 to a price-determination unit 7.

In the mobile radio network MFN, the first switching center V1 and the second switching center V2 and also possibly further network nodes (not shown) in the mobile radio network ascertain network use data NBD1 and NBD2, e.g. by means of measurement, with these network use data NBD1 and NBD2 comprising information about the use of the mobile radio network when the ordering process is performed. Such network use data can be, by way of example, an indication of the duration of a communication link set up for the ordering process, data describing the time at which the communication link is set up and/or an indication of size for the volume of data transmitted using this communication link. These network use data are transmitted from the mobile radio network MFN to the data reception device 1 in the pricing system, and are received by the data reception device 1, as soon as they have been recorded. The network use data are then stored in the data store 5 and are transmitted to the price-determination unit 7.

The price-determination unit 7 now uses the received ordering data and network use data to create a request message N1 for an influence memory 10 connected to the price-determination unit 7. This influence memory 10 stores data comprising information for changing, correcting or influencing price data; these data are referred to as price-influencing data for short. These price-influencing data can be, by way of example, discount table data, bonus data or details of price reductions. These price-influencing data can thus comprise the information regarding how the basic price for the goods or service needs to be reduced when calculating the total price data for the respective ordering process. Similarly, the price-influencing data can also comprise information concerning an increase in the basic price for obtaining the total price data, however. Such an increase can be provided, by way of example, if the ordering process has involved transmission of a particularly large volume of data via the mobile radio network or if the communication link via the mobile radio network has exceeded a predetermined duration.

The request message N1 is output to the influence-memory database 10 via a read output R on the price determination unit 7. Using the network-use-data and ordering-data information contained in the request message N1, the influence memory 10 then addresses the price-influencing data relating to the respective ordering process, reads them and uses the message N5 to return them to the price-determination unit 7. The price-determination unit 7 then uses the ordering data and the price-influencing data received from the influence memory 10 to ascertain the total price data concerning the ordering process. In this example, this can be in a form such that the basic price of the ordered goods is reduced by a percentage contained in the respective price-influencing data. The result produced by this calculation is the total price data, which are output at the output of the price-determination unit 7 and are transmitted to a buffer store 12.

The buffer store 12 initially buffer-stores the total price data. A message N7 is used to transmit the total price data buffer-stored in the buffer store 12 to the provider communication terminal KEG2 and/or to the ordering communication terminal KEG1. This informs the provider of the goods or service and/or the orderer or the ordering device about the total price. The buffer store 12 routes the total price data to a distributor unit 14. This distributor unit 14 is actuated by the price-determination unit 7 such that it splits the total price data into various subgroups of price data. Actuation by the price-determination unit 7 is effected on the basis of the available ordering data, network loading data and the effort put in by the price-determination unit for determining the total price data. In this exemplary embodiment, the total price data are split into mobile-radio price data, provider price data and pricing price data. The mobile-radio price data describe the share of the total price data which arises through the use of the mobile radio network MFN; these mobile-radio price data are stored in a mobile-radio price memory 16. The provider price data describe the share of the total price data which can be attributed to the provider (that is to say to the operator of the provider communication terminal KEG2) and relates to the ordered goods or service. The provider price data are stored in a provider price memory 18. The pricing price data concern the process of ascertaining the total price data which takes place in the pricing system PBS; this is because this ascertainment of the total price data is likewise subject to a cost. The pricing price data are therefore stored in a pricing price memory 20. These special price data (mobile-radio price data, provider price data and pricing price data) can then be supplied directly to further processing, for example in the payment system ZS.

In one variant of the method, information is transmitted to the provider communication terminal KEG2 and/or to the ordering communication terminal KEG1 together with the message N7, said information being used to prompt the provider communication terminal KEG2 and/or the ordering communication terminal KEG1 to check the total price data (e.g. the level of these data) and, in the event of a positive check result, to produce an acknowledgement message BN concerning the total price data and to send it to the pricing system. If such an acknowledgement message BN arrives at the pricing system PBS (e.g. in the buffer store 12), this acknowledgement message BN is then assessed as being agreement to the total price data and is stored in the pricing system PBS. However, if such an acknowledgement message BN does not arrive at the pricing system PBS, then the total price data are marked as “unacknowledged” or are rejected, and the total price data are subjected to special treatment or the method is terminated.

Up to now, the text has described, by way of example, a method sequence in which the price-determination unit 7 has ascertained the total price data merely on the basis of the currently received ordering data BD and network use data NBD1 and NBD2 and also the price-influencing data read from the influence memory 10. In another exemplary embodiment, however, the total price data can also be ascertained in this way using the ordering data and network use data stored in the data store 5 from past ordering processes. To this end, the price-determination unit 7 requests from the data store 5 those “old ordering data” and “old network use data” which have been stored there in connection with ordering processes by the ordering communication terminal KEG1. On the basis of these old data, the price-determination unit 7 then has information about such ordering processes as have already been performed previously using the ordering communication terminal KEG1. These old data are then also used for creating the request message N1 which is sent to the influence memory 10 in order to request the price-influencing data which now need to be used. This means that it is also possible to take into account past ordering processes and, by way of example, to use price reduction data stored in the influence memory, said price reduction data relating to the frequency of ordering (for example taking the number of orders in the current year), the scope of ordering (for example indicated as the monetary value of the goods or services ordered in the last three years) or the frequency with which particular goods or groups of services are ordered (e.g. every third video film ordered per quarter is delivered at a reduced price).

The price-determination unit 7 has a time and data transmitter 9 connected to it. It is therefore possible for the request message N1 also to include the current date and the current time and for, by way of example, table data for time-dependent bonus systems to be read from the influence memory 10.

When new ordering data and network use data arrive at the price-determination unit 7, the price-influencing data stored in the influence memory 10 can be altered. An example of such an alteration is the insertion of a new discount level into a discount table when a particular number of orders is reached per prescribed unit of time. For this purpose, a write output WR on the price-determination unit 7 is then used to send a write message N10 to the influence memory 10; and this write message N10 is used to overwrite parts of the stored price-influencing data with new price-influencing data. In this context, by way of example, the stored price-influencing data, the new ordering data and/or the new network use data are used by the price-determination unit 7 to ascertain the new price-influencing data, using suitable formulae or models. Such alignment of the stored price-influencing data with current ordering processes can affect not just the ordering process currently in progress but also subsequent ordering processes (even those from other orderers).

A particular advantage of the inventive method and the inventive arrangement is that the total price data are ascertained in real time (that is to say while the ordering process is in progress). It is thus possible for the total price data to be ascertained and—as explained above—to be split into more specific subgroups of price data by the distributor unit directly during the order. Hence, when the ordering procedure has finished, it is necessary to store only the total price data and the special price data (e.g. mobile-radio price data, provider price data and pricing price data). It is not necessary, however, to store all ordering, network-use and price-influencing data taken into account when ascertaining the total price data and the special price data in connection with the ordering process (e.g. for subsequently ascertaining the total price data or special price data in a postprocessing step).

The method described allows dynamic pricing and cost distribution, performed online, when performing ordering processes for goods and services. This takes into account the use of a mobile radio network for performing the ordering process (i.e. transport services in the mobile radio network) and uses network-use or network-loading data obtained in the mobile radio network to ascertain the total price data. By using price-influencing data stored in an influence memory, the ordering data and the network-use data can be used to apply a wide variety of price-correction systems (bonus systems, discount systems or price-reduction systems) and to apply the price corrections required as a result of using these price-influencing systems to the basic price data for the goods or services in real time during the ordering process.

1. A method for ascertaining total price data in a mobile-radio-assisted ordering process, in which
following transmission of order data (BUD), performed using a mobile radio network (MFN), from an ordering communication terminal (KEG1) to a provider communication terminal (KEG2) associated with a service provider, a pricing system (PBS) is supplied with ordering data (BD), associated with the order data (BUD), by the provider communication terminal (KEG2),
the pricing system (PBS) uses network use data (NBD1, NBD2), which are transmitted by the mobile radio network (MFN) and appear in connection with the ordering process, to select (N1) from a volume of price-influencing data stored in an influence memory (10) the price-influencing data which are associated with the ordering process, and
the ordering data (BD) and the read (N1, N5) price-influencing data are used to ascertain the total price data concerning the ordering process.

2. The method as claimed in claim 1,
characterized in that
the total price data are ascertained directly after the ordering data (BD) have arrived at the pricing system (PBS).

3. The method as claimed in claim 1 or 2,
characterized in that
ordering data (BD) and network use data (NBD1, NBD2) arriving at the pricing system (PBS) are stored in a data store (5) in the pricing system (PBS).

4. The method as claimed in claim 3,
characterized in that
old ordering data and old network use data stored in the data store (5) in the pricing system (PBS) are used in addition to the network use data (NBD1, NBD2) currently transmitted by the mobile radio network to select (N1) the price-influencing data which are associated with the ordering process.

5. The method as claimed in one of the preceding claims,
characterized in that
upon receipt of current ordering data (BD) or current network use data (NBD1, NBD2), the price-influencing data stored in the influence memory (10) are aligned with these received data by overwriting (N10) a selection of the stored price-influencing data with new price influencing data.

6. The method as claimed in one of the preceding claims,
characterized in that
the ascertained total price data are transmitted to the provider communication terminal (KEG2) and/or to the ordering communication terminal (KEG1).

7. The method as claimed in claim 6,
characterized in that
the provider communication terminal (KEG2) or the ordering communication terminal (KEG1) is prompted to transmit an acknowledgement message (BN) concerning the total price data to the pricing system (PBS),
arrival of the acknowledgement message (BN) at the pricing system (PBS) is registered as a declaration of agreement concerning the total price data, and
failure of the acknowledgement message (BN) to arrive at the pricing system (PBS) causes the total price data to be rejected.

8. The method as claimed in one of the preceding claims,
characterized in that
the ascertained total price data are split (14) into mobile radio price data concerning the mobile radio network (MFN), provider price data concerning the service provider, and pricing price data concerning the pricing system (PBS) on the basis of information contained in the current ordering data (BD) and in the current network use data (NBD1, NBD2).

9. The method as claimed in claim 8,
characterized in that
the mobile radio price data are stored in a mobile radio price memory (16).

10. The method as claimed in claim 8 or 9,
characterized in that
the provider price data are stored in a provider price memory (18).

11. The method as claimed in one of claims 8 to 10,
characterized in that
the pricing price data are stored in a pricing price memory (20).

12. A pricing system (PBS) having
an influence memory (10) for storing a volume of price-influencing data,
a data reception device (1) for receiving ordering data (BD), which concern an ordering process carried out using a mobile radio network (MFN) and for receiving network use data (NBD1, NBD2) for the mobile radio network (MFN), and
a price-determination unit (7), whose input side is connected to the influence memory (10) and to the data reception device (1), for ascertaining total price data concerning the order.

13. The pricing system as claimed in claim 12,
characterized by
a data store (5), whose output side is connected to the price-determination unit (7), for storing incoming ordering data (BD) and network use data (NBD1, NBD2).

14. The pricing system as claimed in claim 12 or 13,
characterized by
a distributor unit (14), connected to the output of the price-determination unit (7), and a plurality of price memories (16, 18, 20) whose input side is connected to the distributor unit (14).
